(19) United States
(12) Patent Application Publication
(10) Pub. No.: US 2024/0055914 A1
(43) Pub. Date: Feb. 15, 2024

(54) TOOTH TIP INSERT FOR DIAMOND COIL WINDING ARRANGEMENTS

(71) Applicant: BorgWarner Inc., Auburn Hills, MI (US)

(72) Inventors: Tim Garner, Cicero, IN (US); Andrew Dragon, Fishers, IN (US); Dave Fulton, Anderson, IN (US)

(21) Appl. No.: 17/818,659

(22) Filed: Aug. 9, 2022

(51) Int. Cl. H02K 1/16; H02K 3/28

(52) U.S. Cl. CPC H02K 1/165; H02K 3/28

(57) ABSTRACT

A stator assembly has a substantially cylindrical core that defines a plurality of winding slots and a plurality of wedge-shaped insert slots, with the winding slots and insert slots alternating around the perimeter face of the core. Each insert slot is wedge-shaped to receive a wedge-shaped insert. The insert includes a cap at one end that is configured to be positioned at the insert slot opening when the insert is disposed within the corresponding insert slot. The cap includes a pair of wings extending therefrom that are sized and configured to overlap a portion of a winding slot on either side of the insert slot when the insert is disposed in said insert slot. The insert slots and inserts include a feature for locking engagement of the inserts in the slots.

### FIELD

The present disclosure relates to electric machines, and particularly to stators for electric machines having diamond coil winding arrangements.

### BACKGROUND

A stator assembly for an electric machine includes a stator core which is comprised of a ferromagnetic material and is typically formed from a plurality of steel sheets that are stamped and stacked upon one another to form a lamination stack. The stator core is generally cylindrical in shape with an inner perimeter face defining an inner diameter of the core. A plurality of teeth are formed on the interior of the stator core and directed inwardly toward the center axis of the stator core. Axial slots are formed in the stator core between adjacent teeth, with two adjacent teeth forming two opposing radial walls for one slot. The stator core is configured to retain a winding arrangement, which for some electric machines can include a plurality of diamond coils that are disposed within the axial slots. As is known in the art, each diamond coil includes in-slot portions that are disposed the slots and that are connected together at the opposite ends of the stator core in a known manner to form the winding arrangement. The diamond coils or conductors of the completed winding arrangement form a plurality of phase windings, such as phase U windings, phase V windings, and phase W windings with multiple paths for each phase.

The in-slot portions are straight portions of the conductors that are introduced radially into the slots. The in-slot portions of multiple diamond coils are aligned in a single file line in each slot. Since many applications of electric motors emphasize reducing the size of the electric machine while improving efficiency, it is desirable to utilize the available slots in a manner that maximizes the filling of the stator slots. High slot fill stators generally produce more electrical power with increased machine efficiency. Use of rectangular conductor wire may achieve a slot fill ratio of 75% or greater. Another approach is to include multiple conductors arranged in a single file line from an innermost end of the slot toward the outermost opening of the slot. With this approach, a plurality of diamond coils are distributed among the stator slots, with the conductors of multiple diamond cols disposed in any given slot.

It is desirable for the slot openings to be at least partially closed for noise reduction and for improvements in stator efficiency. However, in order to insert the diamond coils into the slots, the radial opening of the slot must be wide enough to accept the conductors. There is a need for a stator assembly that can accept radially inserted diamond coils but still provide at semi-closed slot opening.

### SUMMARY OF THE DISCLOSURE

A stator assembly for an electric machine comprises a substantially cylindrical core having opposite axial ends and a perimeter face extending between the axial ends. The core defines a plurality of winding slots extending between the axial ends and having a winding slot opening at the perimeter face. Each of the plurality of winding slots is configured to receive an electrical conductor of a diamond coil therein. The core further defines a plurality of wedge-shaped insert slots extending between the axial ends and having an insert slot opening at the perimeter face. Each of the plurality of insert slots is arranged between a successive pair of the plurality of winding slots around the perimeter face. In other words, the winding slots and insert slots alternate around the perimeter face.

The assembly further includes a plurality of inserts, each insert configured to be received within a corresponding one of the plurality of insert slots. Each insert is an elongated wedge-shaped body to be received in an insert slot. Each insert includes a cap at one end thereof that is configured to be positioned at the insert slot opening when the insert is disposed within the corresponding insert slot. The cap includes a pair of wings extending therefrom. The wings are sized and configured to overlap a portion of a winding slot on either side of the insert slot when the insert is disposed in said insert slot. The wings thus reduce the effective width of the winding slot opening to reduce noise and improve stator efficiency.

In one aspect, the insert slots and inserts include a feature for locking engagement of the inserts in the slots. The locking engagement is configured so that the force to disengage or remove the insert from the slot is at least twice as great as the force to engage the insert in the slot

### DESCRIPTION OF THE DRAWINGS

FIG. 1 is a perspective view of a stator for an electric machine according to one embodiment of the present disclosure.

FIG. 2 is a top view of the stator shown in FIG. 1.

FIG. 3 is a perspective view of a diamond coil for introduction into the stator shown in FIGS. 1-2.

FIG. 4 is a perspective view of a winding arrangement including a plurality of diamond coils of the type shown in FIG. 3.

FIG. 5 is a perspective view of the stator of FIG. 1 incorporating the winding arrangement of FIG. 4.

FIG. 6 is an enlarged axial view of a portion of the stator shown in FIGS. 1-2.

FIG. 7 is an enlarged axial view of the portion of the stator shown in FIG. 6, with conductors of a plurality of diamond coils disposed within a winding slot of the stator.

FIG. 8 is perspective view of a tooth tip insert according to one embodiment of the present disclosure.

FIG. 9 is an axial view of the tooth tip insert shown in FIG. 8.

FIG. 10 is an enlarged axial view of the portion of the stator shown in FIGS. 6-7, with tooth tip insert of FIGS. 8-9 positioned within an insert slot of the stator.

FIG. 11 is an axial view of a tooth tip insert according to another embodiment of the disclosure.

FIG. 12 is an enlarged axial view of an insert slot of a stator, such as the stator of FIGS. 1-2, with the tooth tip insert of FIG. 11, positioned within the insert slot.

FIG. 13 is an enlarged axial view of a portion of a stator with the insert of FIG. 11 positioned in one insert slot.

FIG. 14 is the enlarged axial view of the portion of the stator shown in FIG. 13, with another insert of FIG. 11 partially inserted into another insert slot.

### DETAILED DESCRIPTION

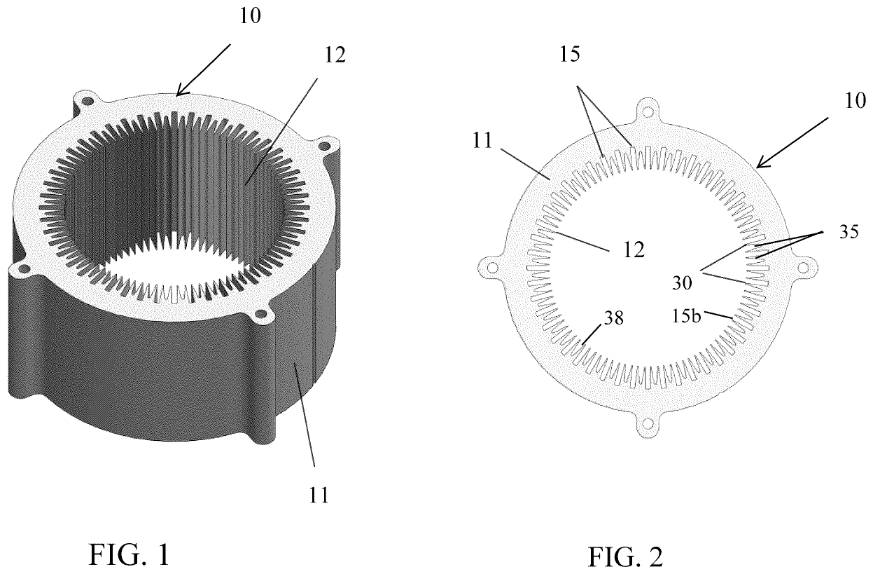

With reference to FIGS. 1-2, a stator assembly 10 includes a stator core 11 which can be formed in a known manner, such as from a plurality of stacked steel sheets. The stator core 11 is generally cylindrical in shape with an inner perimeter face 12 defining an inner diameter of the core. A plurality of teeth 30 are formed on the interior of the stator core 11 and directed inwardly toward the center axis of the stator core. Each tooth 30 extends radially inward, with the tip of the tooth terminating at the inner perimeter face 12. Axial slots 15 are formed in the stator core 11 between adjacent teeth 14, with two adjacent teeth forming two opposing radial walls for one slot.

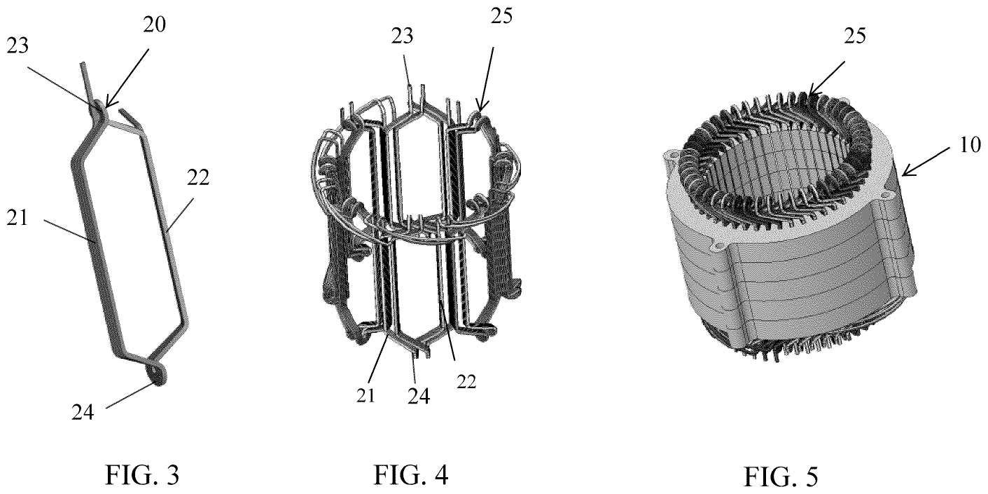

The stator core 11 is configured to retain a winding arrangement in a known manner, such as the winding arrangement 25 depicted in FIGS. 3-5. The winding arrangement 25 includes a plurality of diamond coils 20 that include in-slot portions 21, 22 that are disposed within the axial slots 15. Diamond coils are formed of a plurality of in-slot portions 21 connected to a plurality of in-slot portions 22 by a plurality of end loop portions 23, 24 on both ends, creating the diamond shape as shown FIG. 3. The in-slot portions 21 of the diamond coils are radially introduced into one of the slots 15 and the in-slot portions 22 are radially introduced into another one of the slots 15. The leads of each diamond coil are then connected together as shown in FIGS. 4-5 to form the winding arrangement 25. The in-slot portions of multiple diamond coils 20 are aligned in a single file line in each slot. Thus, as shown in FIG. 7, six layers of conductors 21, 22 of diamond coils 20 are arranged in a single file line from an innermost end 15a of the slot toward the outermost opening 15b of the slot 15.

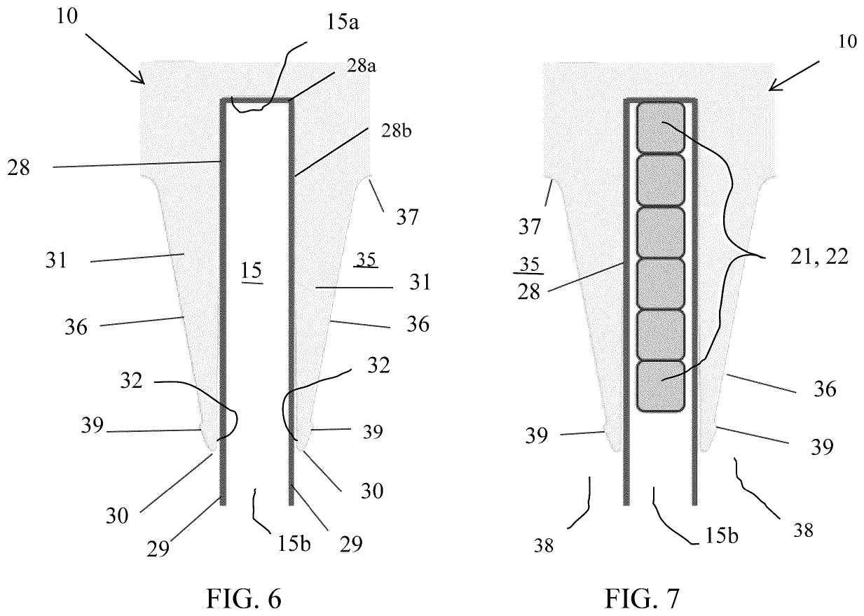

Details of the teeth 30 in accordance with certain embodiments are shown in FIGS. 6-7. In particular, teeth 30 extend radially toward the center axis of the cylindrical stator core, terminating at the inner perimeter 12. Each tooth is formed by a slightly flexible leg 31 that includes a slot surface 32. As shown in FIG. 6, the slot surfaces 32 of successive teeth 30 define the radial walls of the slot 15. The slot surfaces 32 extend radially from the base 15a of the slot to the opening 15b. In one embodiment, the slot surfaces of successive teeth are parallel to each other. In another embodiment, as shown in FIG. 6, the slot surfaces 32 of successive teeth flare outward away from each other from the base 15a, or from an intermediate position along each tooth 30, to the opening 15b. More particularly, the adjacent flexible legs 31 on opposite sides of a slot 15, diverge form each other, as shown in FIG. 6.

As shown in FIG. 7, the in-slot portions 21, 22 of six diamond coils are disposed in line within the slot 15. It can be appreciated that the width of the slot 15, as defined between the surfaces 32 of the flexible legs, is sized to accommodate the in-slot portions in a close fit. In certain embodiments, a U-shaped insulator 28 can be disposed within the slot 15, with the in-slot portions 21, 22 disposed within the insulator. As shown in FIGS. 6-7, the insulator is U-shaped with a base 28a seated at the base 15a of the slot. Two arms 28b extend from the base and have a length that is greater than the radial depth of the slot 15. In particular, end portions 29 of the insulator project beyond the opening 15b of the slot, at least initially when the stator core and winding arrangement are being assembled.

As shown in FIG. 2, the stator core 11 includes insert slots 35 disposed between winding slots 15. As shown in FIGS. 6-7, each tooth 30 includes a wedge surface 36 on the face of the tooth circumferentially opposite the slot surface 32. In other words, one face of the tooth forms the slot surface 32 and the other face forms the wedge surface 36. Each insert slot 35 is thus defined by the wedge surfaces 36 of successive teeth. The insert slot 35 is closed at a radially outboard base 37 and defines a radially inboard opening 38 at the inner perimeter surface 12. In the illustrated embodiment, the wedge surfaces 36 of successive teeth are angled to diverge from each other toward the inboard opening 38 of the insert slot. Thus, as shown in FIG. 2, the insert slots 35 have a generally triangular or wedge-shaped axial cross-section, whereas the winding slots 15 are generally rectangular axial cross-section.

The wedge surface 36 of each tooth 30 defines a locking tip 39 at the radially inboard end of the flexible leg 31. In one embodiment, the locking tip 39 is in the form of a projection or rib that projects from the wedge surface 36 into the inboard opening 15b.

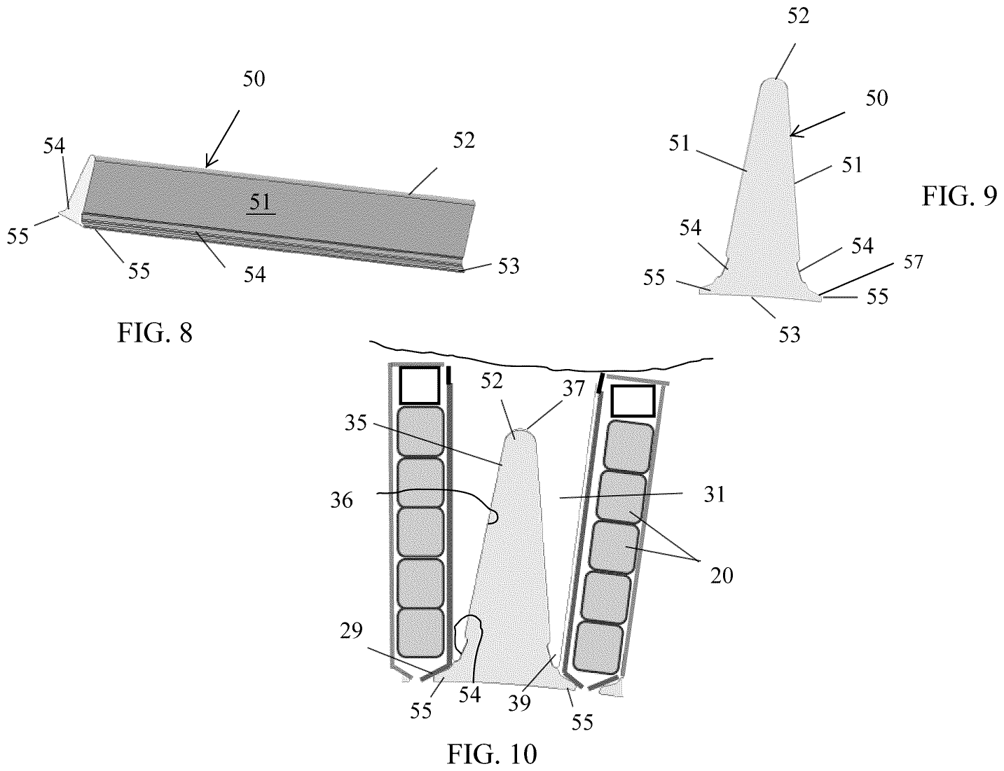

The insert slot 35 is configured for locking engagement with a tooth tip insert 50, shown in FIGS. 8-9. The insert is an elongated body sized to extend along the axial length of the stator core. The insert 50 is a generally triangular wedge shape, with opposite angled sides 51 terminating in a rounded apex 52. The insert 50 is configured so that the angled sides 51 contact the wedge surfaces 36 of the adjacent teeth 30 when the rounded apex 52 is in contact with the base 37 of the insert slot 35, as shown in FIG. 10. The insert 50 includes a cap 53 with outwardly extending wings 55. The wedge surfaces 51 each define a locking notch 54 that is arranged to engage the locking tip 39 of an adjacent tooth 30.

In one feature of this embodiment, the angled sides 51 of the tooth tip insert 50 subtend an angle that is slightly larger than the angle subtended by the wedge surfaces 36 of the adjacent teeth 30. In a specific embodiment, the angled surfaces 51 of the tooth tip insert 11 can subtend an angle of 10-12°, while the wedge surfaces 36 of the teeth 30 at either side of the insert slot 35 can subtend an angle of 8-10°. As shown in FIGS. 6-7, the flexible legs 31 of the teeth on either side of a winding slot 15 are biased apart from each other at the winding slot opening 15b. Consequently, the same teeth will be biased toward a successive tooth on the opposite side of the insert slot 35. However, when the tooth tip insert 50 is introduced into an insert slot 35, the angled surfaces 51 of the insert pushes the successive teeth outward relative to the insert slot, which in turn pushes the teeth on opposite sides of the insert slot into the adjacent winding slot. It can be appreciated, then, that as the inserts 50 are introduced into each insert slot, successive teeth move toward each other in each of the winding slots. Slightly closing the winding slots around the conductors of the diamond coils 20 increases the slotfill (i.e., area of copper/cross sectional area of the slot) of the stator assembly, which can impact stator performance and efficiency.

The insert 50 is pushed into the insert slot 35 until the locking tips 39 of the adjacent teeth snap into an associated locking notch 54. When a tooth tip insert 50 is locked within an insert slot 35, the flexible legs 31 of the adjacent teeth 30 have deflected to narrow the winding slot opening 15b. In addition, the wings 55 of the cap 53 of the insert 50 overlap part of the openings 15b of the adjacent winding slots 15. As can be seen in FIG. 10, the wings 55 significantly reduce the width of the opening 15b. In one embodiment, the wings 55 of the cap 53 can reduce the effective width of the opening by at least 50%. The wings can be configured to nearly touch each other across the winding slot opening 15b, in which case the wings reduce the effective width of the winding slot opening by almost 100%.

When an insulator 28 is present in the winding slot 15, an angled underside 57 of the cap 53 of the insert 50 bears against the end portions 29 of the insulator. As the insert is pushed further into the insert slot 35, the angled underside 57 gradually bends the end portions 29 inward across the slot opening 15b, as shown in FIG. 10. This feature further reduces the width of the winding slot opening 15b. In a specific embodiment, the end portions 29 can be sized so that they reduce the width of the winding slot opening by 70-80%. The width reduction achieved by the tooth tip inserts 50 provides significant benefits in nose reduction and stator efficiency.

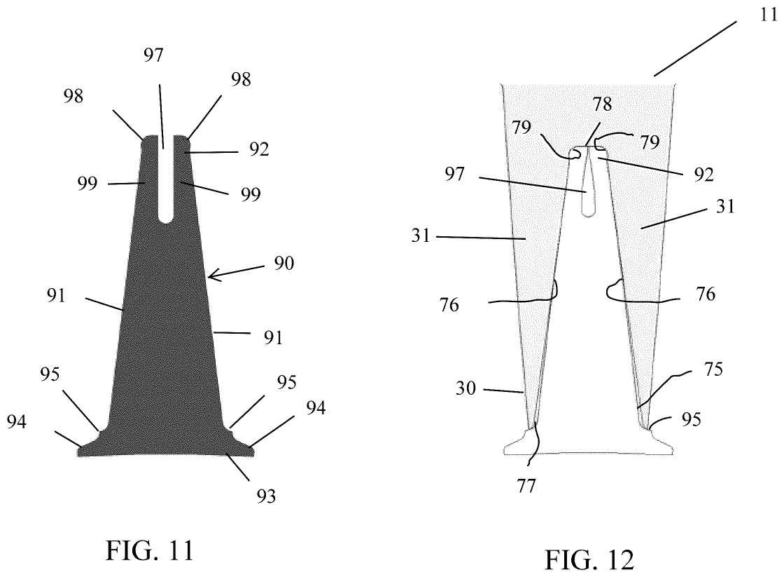

In another embodiment, the insert slot and tooth tip insert incorporate a different locking mechanism between the two components. The tooth tip insert 90 shown in FIGS. 11-14 has the similar wedge-shaped configuration as the insert 50. Thus, the insert 90 includes angled sides 91 that converge to an apex 92. The opposite end of the insert includes a cap 93 that includes wings 94, like the insert 50. The underside of the wings 94 can define a step 95 that can bear against the top of a tooth, as best seen in FIG. 12. In this embodiment, the locking mechanism is at the apex 92 of the insert. In particular, the apex includes a slot 97 defined between arms 99. The ends of the arms 99 include an enlargement 98, preferably having a generally circular shape.

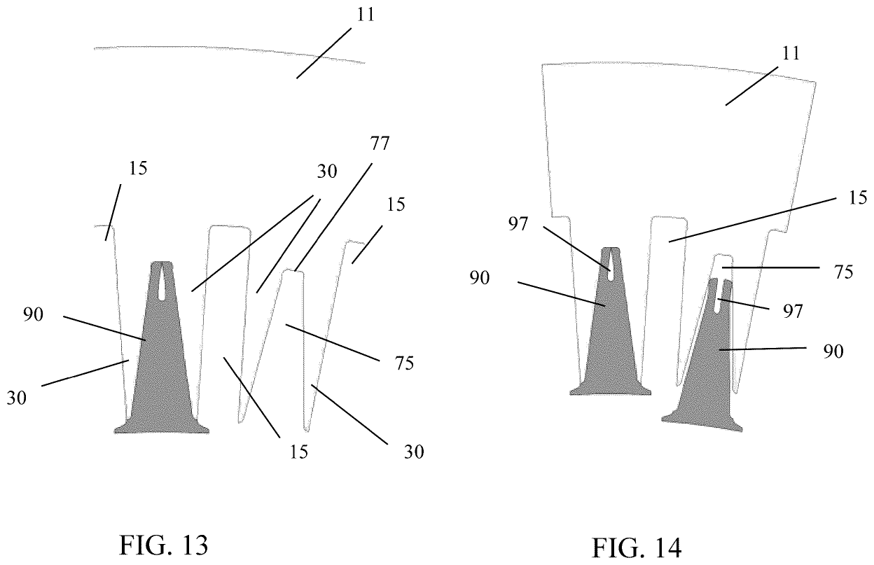

The tooth tip insert 90 is configured to be pressed into an insert slot, such as the insert slot 75 shown in FIG. 12. Like the slot 35, the slot 75 is defined in the stator core 11 between the flexible legs 31 of successive teeth 30, as shown in FIGS. 13-14. The teeth 30 also define the winding slots 15, as described above. The insert slot 75 is defined between the wedge surfaces 76 of the teeth. The radially outward base 78 of the insert slot defines a pair of recesses 79 that are configured to receive the enlargements 98 of the insert to lock the insert in place. As shown in FIGS. 12, 14, when the insert 90 is initially introduced into the insert slot 75, the slot 97 is in the original open configuration shown in FIG. 11. As the insert is pushed deeper into the slot 75, the angled wedge surfaces 36 of the adjacent teeth gradually push the arms 99 towards each other, thereby closing the slot 97. When the insert is at the full depth of the insert slot, the arms 99 flex outward slightly so that the enlargements 98 become fully engaged within the respective recesses 79. The slot 97, enlargements 98, insert slot 75 and recesses 79 can be configured so that the ends of the arms 99 are closely adjacent each other when the enlargements are fully seated within the recesses.

The insert 90 of this embodiment does not require that the legs 31 of the teeth 30 are flexible, as required for the insert 50. In this embodiment, the legs 31 do not need to flex outward to accommodate the insert. Nevertheless, it is contemplated that the legs 31 of the stator teeth can still be flexible and can still be deflected outward slightly by the angled surfaces 91 upon full insertion of the insert 90 into the insert slot 75. This feature can add an extra clamping force to hold the insert 90 within the insert slot, as the insert is clamped between opposing legs 31. Moreover, the flexible legs are initially angled toward each other across the insert slot, thereby widening the opening 15b of the winding slots 15 prior to insertion of the tooth tip insert 90, which can facilitate insertion of the diamond coils 20 as described above. An additional benefit of having flexible legs 31 of the teeth is that the entire leg can be pushed outward by the insert, thereby reducing the clearance between the slot surfaces 32 of the legs and the in-slot portions 21, 22 of the diamond coils 20 within the winding slots 15. As with the insert 50, the inserts 90 slightly close the winding slot around the conductors which increases the slotfill of the stator assembly.

It can be appreciated that the locations of the enlargements 98 and recesses 79 can be reversed—namely, that the ends of the insert arms 99 can define the recesses and the base 78 of the insert slot 75 can define the enlargements. The engagement between the modified enlargements and recesses effectively locks the insert 90 fully within the insert slot 75 so that the insert cannot be inadvertently dislodged.

In each of the embodiments disclosed herein, the stator core 11 defines alternating winding slots 15 and insert slots 35, 75. In particular, the laminations forming the stator core are all provided with radial teeth around the inner circumference of the core, with the generally radially extending sides or surfaces of the teeth defining the winding slots and insert slots. The inserts 50, 90 are elongated with a length equal to or slightly less than the axial length of the stator core. The inserts 50, 90 may be formed of a magnetic material such as a stack of thin electrical steel, iron or cobalt, or a powdered metal such as a soft magnetic composite (SMC). Since the flux lines are mostly in two opposite directions parallel to the slot 97, the inserts 50, 90 may also be formed of a stack of grain-oriented steel laminate material. To form the stack, the laminates may be welded or bonded together.

The locking features of the two embodiments are configured for a snap-fit engagement, which provides a positive lock between the engaging components as well as a tactile indication that the tooth tip inserts 50, 90 have been properly installed in the stator assembly 10. The inserts can be removed by pulling the inserts radially inward, but the pull-out force is significantly greater than the insertion force, to reduce the risk of inadvertent dislodgement of an insert. In one specific embodiment, the locking features—namely the locking tip 39 and notch 54, and the enlargement 98 and recess 79—are configured so that the pull-out force is at least twice the push-in force.

It can be appreciated that the width and depth of the winding slots 15 and of the intervening insert slots 35, 75, relative to the overall dimensions of the stator core, can be determined by the type and number of conductors or in-slot portions 21, 22 disposed within the winding slots 15, as well as by the number of winding slots around the inner perimeter face 12 of the stator core. In the illustrated embodiments, the radial depth of the winding slots is greater than the radial depth of the insert slots. In a specific embodiment, the depth of the insert slots 35, 75 is about 75% of the radial depth of the winding slots 15, while the widths of the insert slot openings 38, 78 are greater than the width of the winding slot openings 15b.

The foregoing detailed description of one or more embodiments of the tooth tips and diamond coils for an electric machine has been presented herein by way of example only and not limitation. It will be recognized that there are advantages to certain individual features and functions described herein that may be obtained without incorporating other features and functions described herein. Moreover, it will be recognized that various alternatives, modifications, variations, or improvements of the above-disclosed embodiments and other features and functions, or alternatives thereof, may be desirably combined into many other different embodiments, systems or applications. Presently unforeseen or unanticipated alternatives, modifications, variations, or improvements therein may be subsequently made by those skilled in the art which are also intended to be encompassed by the appended claims. Therefore, the spirit and scope of any appended claims should not be limited to the description of the embodiments contained herein.

Various embodiments are presented in the drawings and in the accompanying description. Alternate embodiments of the present disclosure and their equivalents may be devised without parting from the spirit or scope of the present disclosure. For instance, in the present disclosure the stator assembly 10 defines the winding slots and the insert slots on the radially inner perimeter face 12, but the slots can be defined on the radially outer perimeter face of the stator core 11. Moreover, in the embodiment of FIGS. 11-14, the insert slot 75 and tooth tip insert 90 can be generally rectangular in shape, rather than wedge-shaped, except at the base 78 of the slot and apex 92 of the insert. In this modification, the teeth 30 are not deflected by the insert 90 as it is introduced into the insert slot.

It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the particular features, structures, or characteristics of the given embodiments may be utilized in connection or combination with those of any other embodiment discussed herein.

What is claimed is:

1. A stator assembly for an electric machine comprising:
a substantially cylindrical core having opposite axial ends and a perimeter face extending between said axial ends, said core defining;
a plurality of winding slots extending between said axial ends and having a winding slot opening at said perimeter face, each of said plurality of winding slots configured to receive an electrical conductor therethrough;
a plurality of insert slots extending between said axial ends and having an insert slot opening at said perimeter face, each of said plurality of insert slots arranged between a successive pair of said plurality of winding slots around the perimeter face; and
a plurality of teeth circumferentially spaced around said perimeter face, said plurality of teeth defining said plurality of winding slots and said plurality of insert slots between successive teeth;
a winding arrangement including a plurality of diamond coils, each of said diamond coils being an electrical conductor with a pair of in-slot portions configured to be introduced radially into a corresponding two of said plurality of winding slots; and
a plurality of inserts, each insert configured to be received within a corresponding one of said plurality of insert slots, each insert being elongated and including a cap at one end thereof that is configured to be positioned at said insert slot opening when said insert is disposed within the corresponding insert slot, said cap including at least one wing extending therefrom, said wing sized and configured to overlap a portion of the winding slot opening of one of the successive pair of said plurality of winding slots when the insert is disposed in said insert slot,
wherein each of said plurality of teeth is flexible so that when one of said plurality of inserts is inserted into one of said plurality of insert slots, said successive teeth are deflected apart.

2. The stator assembly of claim 1, wherein said at least one wing includes two wings, each of said two wings configured to overlap a portion of the winding slot of a different one of the successive pair of said plurality of winding slots.

3. The stator assembly of claim 2, wherein said insert slot opening has a width and said two wings overlap said winding slot to reduce the width of said insert slot opening.

4. The stator assembly of claim 3, wherein said two wings are sized to reduce the width of said insert slot opening by at least fifty percent (50%).

5. The stator assembly of claim 1, wherein:
each of said plurality of winding slots has a substantially rectangular axial cross section;
each of said plurality of insert slots has a substantially wedge-shaped axial cross section; and
each of said plurality of inserts has a substantially wedge-shaped axial cross section.

6. The stator assembly of claim 5, wherein:
each of said plurality of winding slots extends a radial depth into said core; and
each of said plurality of insert slots extends a radial depth into said core that is less than the radial depth of said plurality of winding slots.

7. The stator assembly of claim 1, wherein each of said plurality of teeth includes a first surface defining a wall of one of said plurality of winding slots and an opposite second surface defining a wall of one of said plurality of insert slots.

8. The stator assembly of claim 7, wherein:
said plurality of insert slots have a wedge-shaped axial cross section subtending a first angle; and
said plurality of inserts have a wedge-shaped axial cross section subtending a second angle that is greater than said first angle.

9. The stator assembly of claim 1, further comprising a locking mechanism defined between a corresponding insert slot of said plurality of insert slots and a corresponding insert of said plurality of inserts configured to lock said corresponding insert within said corresponding insert slot.

10. The stator assembly of claim 9, wherein said locking mechanism includes a snap-fit engagement between said corresponding insert slot and said corresponding insert.

11. The stator assembly of claim 10, wherein said locking mechanism is configured so that the force for disengaging the corresponding insert slot and the corresponding insert from said snap-fit engagement is at least twice as great as the force for engaging the corresponding insert slot and the corresponding insert in said snap-fit engagement.

12. The stator assembly of claim 10, further comprising:
a plurality of teeth circumferentially spaced around said perimeter face, said plurality of teeth defining said plurality of winding slots and said plurality of insert slots between successive teeth, each of said plurality of teeth including a first surface defining a wall of one of said plurality of winding slots and an opposite second surface defining a wall of one of said plurality of insert slots,
wherein said locking mechanism includes;
an enlargement defined on said second surface of each of said plurality of teeth; and
a notch defined in said insert slot adjacent said insert slot opening, said notch configured to receive said enlargement therein.

13. The stator assembly of claim 10, wherein said locking mechanism includes:
a slot defined in an apex at an end of said insert opposite said cap;
at least one enlargement defined on said apex; and
at least one recess defined at an end of said insert slot opposite said insert slot opening, said at least one recess configured to receive said at least one enlargement therein,
wherein said apex of said insert is configured to deform to compress said slot when said at least one enlargement is received in said at least one recess.

14. The stator assembly of claim 1, further comprising a U-shaped insulator disposed in each of said plurality of winding slots, said insulator including free ends extending out of the winding slot opening of each of said plurality of winding slots.

15. The stator assembly of claim 14, wherein each of said free ends of said U-shaped insulator is configured to be bent by one insert of said plurality of inserts when the one insert is inserted into one of said plurality of insert slots, said free ends sized to overlap a portion of the winding slot opening of one of the successive pair of said plurality of winding slots when the free end is bent.

16. The stator assembly of claim 1, wherein each of the plurality of inserts is formed of grain-oriented steel.

17. The stator assembly of claim 16, wherein said winding arrangement is configured so that two or more in-slot portions are received in each of said plurality of winding slots.

18. The stator of claim 1, wherein the adjacent ones of said plurality of teeth defining one of said plurality of winding slots are angled to diverge from each other toward the winding slot opening, prior to the plurality of inserts being inserted into the plurality of insert slots.

19. An insert for receipt in a radial slot of a stator core comprising:
a wedge-shaped elongated body having opposite angled sides extending along a length of said body, said angled sides converging to an apex of said body;
a cap at an end of said body opposite said apex, said cap including a pair of wings extending outward therefrom; and
a locking feature for locking engagement of a complementary locking feature in the radial slot of the stator core when the apex of said body is inserted into the radial slot.

20. The insert of claim 19, wherein said locking feature includes a notch defined in each of said opposite angled sides adjacent said cap.

21. The insert of claim 19, wherein said locking feature includes:
a slot defined in said apex extending in said body toward said cap; and
at least one enlargement defined on said apex, wherein said apex is configured to deform to compress said slot when said at least one enlargement is received in the radial slot of the stator core.
